(19) United States
(12) Patent Application Publication
(10) Pub. No.: US 2026/0180707 A1
(43) Pub. Date: Jun. 25, 2026

(54) EMISSIONS MITIGATION SYSTEM FOR SECURE SPACE EAVESDROPPING PROTECTION

(71) Applicant: NORTHROP GRUMMAN SYSTEMS CORPORATION, Falls Church, VA (US)

(72) Inventors: Peter B. Houser, Poway, CA (US); Michael P. Johnson, Poway, CA (US); Derek Praeger, San Diego, CA (US)

(73) Assignee: NORTHROP GRUMMAN SYSTEMS CORPORATION, Falls Church, VA (US)

(21) Appl. No.: 18/989,579

(22) Filed: Dec. 20, 2024

(51) Int. Cl. H04K 3/00

(52) U.S. Cl. CPC H04K 3/827

(57) ABSTRACT

The EMS is installed and operated within a sensitive area. The EMS emits RF signals that interfere with hostile eavesdropping systems by mitigating the signals that are inherently emitted within the sensitive facility. The EMS may be configured to operate in “hard spaces” (e.g., SCIFs) that have existing physical emissions protections, in “soft spaces” (e.g., tents) that do not have any such physical protections, or in open spaces. The EMS may be configured to operate within a static context that is based solely upon a known local environment and threat. Alternatively, the EMS may be configured to operate within a dynamic context that is based upon ongoing RF reception and analysis within the sensitive area.

### FIELD OF THE INVENTION

The present invention relates to a mitigation system that creates an emissions mitigation system (EMS), which may be thought of as a “virtual Faraday cage,” and is installed to provide or enhance eavesdropping protection within and around a sensitive area. The EMS may be tuned to operate within policies that are specific to the installation location (e.g., US FCC, Foreign or International communications standards, medical devices, controlled/uncontrolled, HERX/HERO).

### BACKGROUND

Military and civilian organizations often desire to protect the radio frequency (RF) signals that are inherently generated within an area from external eavesdropping. RF attenuating barriers are often used to promote this goal but are expensive, inconvenient, and may not be sufficient. Faraday cages are a known solution for protecting sensitive areas. Many military and commercial organizations utilize Sensitive Compartmented Information Facilities (SCIFs) that incorporate a Faraday cage.

However, existing RF attenuating barriers are generally expensive, inconvenient, and may not provide sufficient signal attenuation. There is a need for systems that can replace or augment existing RF attenuating barriers to provide to provide RF eavesdropping protection that is less expensive, more convenient, and more capable against evolving eavesdropping equipment.

Further, the National Security Agency (NSA) regularly revises standards for SCIF protection against RF eavesdropping. The cost for upgrading a typical current SCIF facility to the most recent standards may be two million dollars or more per site. A means of meeting the revised standards without infrastructure upgrades would be very valuable. Therefore, a need exists for a mitigation system that improves the resistance to eavesdropping whether or not physical barriers, such as Faraday cages, are also in place.

### SUMMARY

The EMS of the present invention is based upon a conventional jammer such as systems currently fielded by NGMS (Northrop Grumman Mission Systems). The EMS is installed and operated within a sensitive area. The EMS emits a mitigation signal (e.g., an RF signal) that interferes with hostile eavesdropping systems by disrupting the signals that are inherently emitted within the sensitive facility by user devices rather than only disrupting hostile sensors and communications devices. The EMS may be configured to operate in “hard spaces” (e.g., SCIFs) that have existing physical emissions protections, in “soft spaces” (e.g., tents) that do not have any such physical protections, or in the open environment. The EMS may be configured to operate within a static context that is based solely upon a known local environment and threat. Alternatively, the EMS may be configured to operate within a dynamic context that is based upon ongoing RF reception and analysis to sense specific signals within the sensitive area.

The EMS may include controls for HERX/HERO-approved safe transmission levels. The system may be configurable for US-based Controlled Facilities (e.g., government buildings, airports) or for Uncontrolled Facilities (everywhere else). The system may be configurable for compliance with international standards or local laws that may relevant outside the continental United States. The EMS includes one or more sensors. When using the sensors, the EMS may be configured to identify the specific signals as a composite of the individual sensor feeds. Alternatively, the EMS might use beamforming methods to create directional sensor feeds that are specific to a smaller region within the secure area.

The EMS includes one or more emitters. When using the emitters, the EMS may be configured to modify the characteristics of emitted signals from the emitters in such a way that the resulting combined signal provides improved mitigation performance and improved performance against hostile eavesdropping. For example, beamforming methods might be used to create directional interfering signals directed towards signals emitted from specific user devices.

### BRIEF DESCRIPTION OF THE DRAWINGS

FIG. 1 depicts a system diagram showing the EMS used to establish or enhance a sensitive space boundary according to an embodiment of the invention.

FIG. 2 highlights the components of FIG. 1 involved in power monitoring and distribution according to an embodiment of the invention.

FIG. 3 highlights the components of FIG. 1 involved in sensitive space administration and user operation according to an embodiment of the invention.

FIG. 4 highlights the components of FIG. 1 involved in emission mitigation according to an embodiment of the invention.

FIG. 5 depicts example components of a digital antenna according to an embodiment of the invention.

FIG. 6 depicts example components of the power monitoring and distribution system according to an embodiment of the invention.

FIG. 7 depicts example components of the SAMS used for creating virtual channels according to an embodiment of the invention.

FIG. 8 depicts a software defined radio according to an embodiment of the invention.

FIG. 9 depicts a flowchart showing the steps used for mitigation according to an embodiment of the invention.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

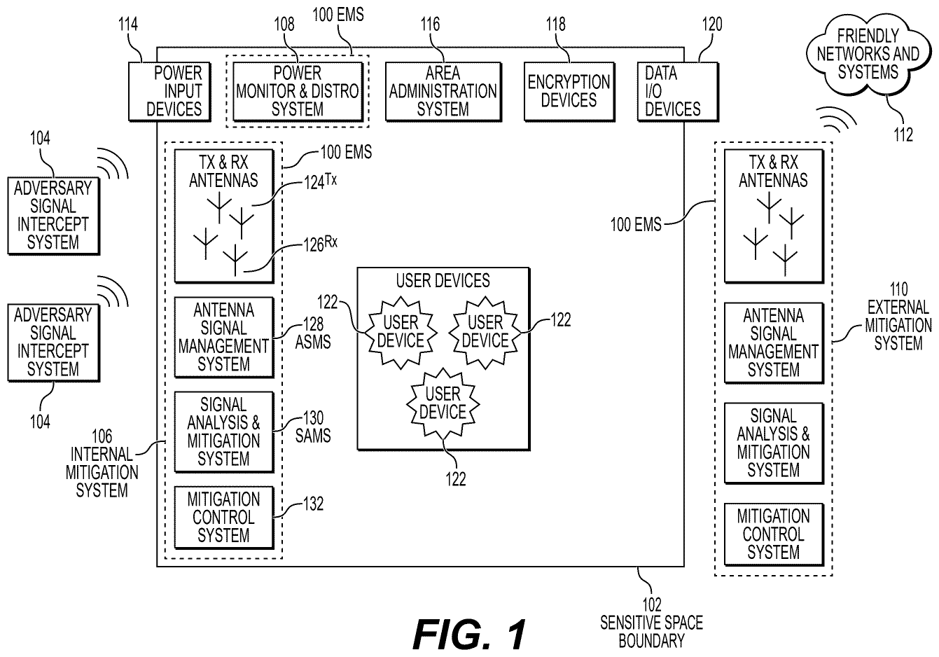

FIG. 1 depicts a system environment of EMS 100 which operates within or establishes a sensitive space boundary 102 (e.g., corresponding to the boundary of a SCIF). As previously discussed, most prior art solutions for sensitive space boundaries 102 involved passive measures such as using Faraday cages which require expensive upgrades to stay compliant with current regulations. The EMS 100 of the present invention can be used in conjunction with existing sensitive space boundaries 102 (e.g., with a Faraday cage) or alone as a means of adverse signal interception and mitigation from adversary signal intercept systems 104.

Generally, EMS 100 comprises internal mitigation system 106, power monitor and distribution system (PMDS) 108, and external mitigation system 110. The use of the term “internal” in internal mitigation system 106 refers to sensitive space boundary 102 and not to a physical location of the internal mitigation system 106 or external mitigation system 110. For example, internal mitigation system 106 may emit RF mitigation signals such that no unintended RF signals (e.g., from user devices 122) leave sensitive space boundary 102 whereas external mitigation system 110 may be used to receive external RF signals from friendly networks or systems 112 and/or used to measure the effectiveness of EMS 100 as will be described later.

Generally, within a SCIF or other sensitive space boundary 102, a plurality of other systems or components also operate which may include, but are not limited to, power input devices 114, area administration system 116, encryption devices 118, data I/O devices 120, and user devices 122. Power input devices 114, area administration system 116, encryption devices 118, and I/O devices 120 are “trusted” components that do not (necessarily) require mitigation and EMS provide multiple functions related to sensitive space administration and user operation.

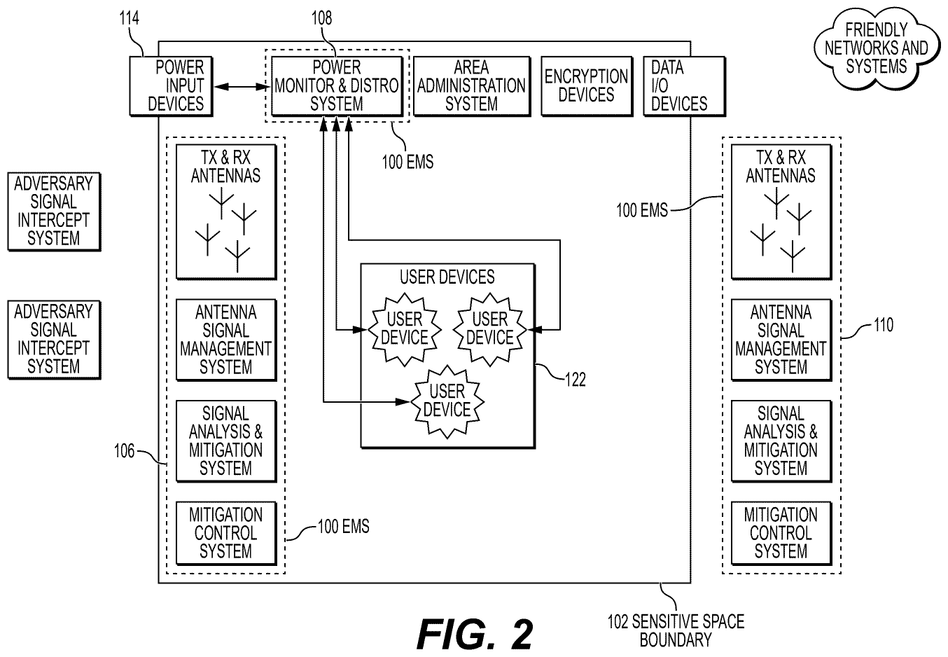

As depicted in FIG. 2, the area administration system 116 and encryption devices 118 are “trusted” so their power and ground characteristics do not require monitoring. However, PMDS 108 monitors all other power supplied throughout sensitive space boundary 102 such as power from power input devices 114 and power to user devices 122. Accordingly, PMDS 108 comprises its own mitigation system for mitigating any signals that may be propagated over components of the power system, such as power lines or power supplied to user devices 122.

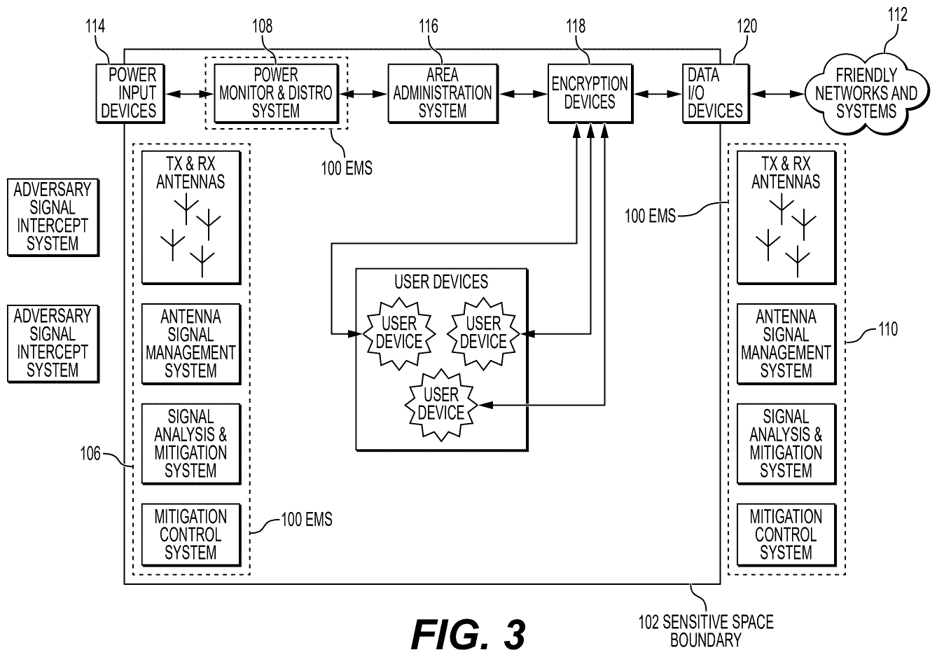

The EMS 100 further monitors user devices 122 to ensure compliance with any local rules and to ensure proper RF emission levels within (or external to) sensitive space boundary 102 are not exceeded as depicted in FIG. 3. For example, external mitigation system 110 may be used to monitor the strength of any emitted signals to ensure they do not exceed those specified by local laws or regulations.

Compliance verification and recording (e.g., for security, regulatory, and safety) may be performed by mitigation control system 132. Different alarms might be inherent or dedicated. Access to many components of EMS 100 might be privileged or restricted to different levels of access as is known in the art.

EMS 100 may be deployed in a variety of settings including:
within a permanent sensitive space facility (SCIF) to provide additional protection or to meet evolving certification requirements;
within a permanent but currently unprotected space;
for transitory needs, e.g., battleforce on the move, flightline operations; and
large spaces (e.g., an airport hangar) might need several EMSs 100.

Encryption devices 118 may include one or more High Assurance Internet Protocol Encryptors (HAIPE) for encrypting all communication exchanged between friendly networks and systems 112 and user devices 122.

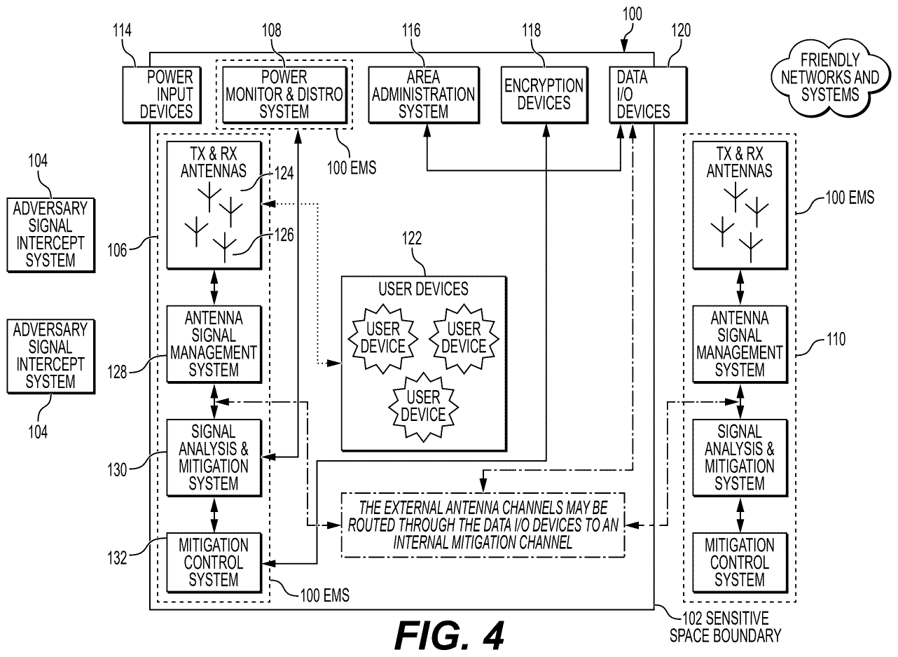

As depicted in FIG. 4, the mitigation signals are primarily emitted through internal mitigation system 106. Internal mitigation system 106 generally comprises transmit antenna(s) 124, reception antenna(s) 126, antenna signal management system (ASMS) 128, signal analysis and mitigation system (SAMS) 130, and mitigation control system (MCS) 132. Based on the results of signal analysis and mitigation system 130, EMS 100 causes the transmit antennas 124 to mitigate any RF (or other) emissions from user devices 122 (or any other components within sensitive space boundary 102) so they cannot be demodulated by adversary signal intercept systems 104. In some embodiments, external mitigation system 110 comprises similar or the same components as internal mitigation system 106. The channels from external mitigation system 110 may be routed through data I/O devices 120 to an internal mitigation channel to measure the effectiveness of EMS 100.

### User Device 122 Characteristics

As used herein, “user devices” 122 encompasses all components placed within the sensitive space boundary 102 that are not included within the Administration or EMS 100. User devices 122 may include:
all types of cables and connectors;
all information processing systems;
all information storage systems or devices; and
all personal electronic devices

In a preferred embodiment, all user devices 122 are evaluated and approved before placement within the sensitive area. The RF and power characteristics of each user device 122 are measured, analyzed, and characterized before operation so any anomalies with user devices 122 can be detected more easily. The MAC address, or other unique identifier, of each user device 122 may be used to track the devices on any wired or wireless networks within sensitive space boundary 102.

User device 122 emissions will often correspond to known components within the devices and those component's emissions characteristics. Mitigating techniques from EMS 100 may be specific to user devices 122 or may be generically relevant to classes of user devices 122. For example, the mitigation techniques may depend upon the network capabilities of the user device (e.g., 4G, 5G, BT, Wi-Fi, etc.).

### Transmit Antennas 124 and Reception Antenna 126 Characteristics

The following description may apply to transmit antennas 124 and reception antennas 126 utilized in either internal mitigation system 106 or external mitigation system 110. The reception antennas 126 are utilized to sense RF emissions from the user devices 122. The received signals are then digitized and analyzed to determine one or more mitigation signals using mitigation techniques. Transmit antennas 124, in turn, emit the mitigation signals(s) that mitigate the user device 122 emissions. The individual antennas within internal mitigation system 106 may be reception antennas, transmit antennas, or a combination.

The antennas 124 and 126 for internal mitigation system 106 or external mitigation system 110 are selected for response in the bands that correspond to emissions of the user devices 122 within sensitive space boundary 102. The antennas 124 and 126 may incorporate conventional analog designs or digital radioheads (including A/D, D/A, LNA (low-noise amplifier), PA (power amplifier), Rx (reception) filtering, and Tx (transmission) filtering). Antennas for internal mitigation system 106 may be placed throughout the sensitive space boundary 102 in order to ensure a strong RF path to/from each user device 122. Antennas 124 and 126 may have differing characteristics in order to address all reception and transmission needs for all user device 122 emissions. The antenna suite may be simple, or it may be complex in order to effectively mitigate a large suite of user devices 122.

### PMDS 108 Characteristics

The PMDS 108 accepts power from an appropriate (e.g., monitored) source and distributes “clean power” to other components within the sensitive space boundary 102. The PMDS 108 also provides “clean” grounding to other components in the sensitive space boundary 102. In particular, the PMDS 108 segregates the power and ground lines for each user device 122 or group of user devices 122 and monitors the characteristics of each power line. The PMDS 108 mitigates power and ground emissions by emitting power signals onto corresponding power and ground lines. The PMDS 108 exchanges data and alarms with the SAMS 130.

### ASMS 128 Characteristics

The ASMS 128 exchanges signals with each antenna 124 or 126 in internal mitigation system 106 and/or external mitigation system 110. The antenna signals may be analog (conventional antenna) or digital (digital radiohead). Digital antenna connections may be networked. In a preferred embodiment, fiber optics are used when possible for communication within sensitive space boundary 102.

The ASMS 128 exchanges digital signals with SAMS 130, preferably using an open standard such as VITA 49.2 or equivalent commercial standards. When using conventional antennas, the ASMS 128 provides A/D, D/A, LNA, PA, Rx filtering, and Tx filtering. The ASMS 128 isolates the rest of the system within internal mitigation system 106 from any analog signals. Digital radioheads may provide some of the required A/D, D/A, LNA, PA, Rx filtering, and Tx filtering capabilities.

In some embodiments, the ASMS 128 may provide signal manipulation including time shifting and/or combining channels and MIMO methods to address multipath transmission paths. Such signal manipulation creates a more focused synthetic channel that may enhance signal reception and/or transmission quality and utility.

### SAMS 130 Characteristics

The SAMS 130 exchanges digital signals with other components of EMS 100 in order to characterize and mitigate emissions. The SAMS 130 comprises many “mitigation channels”, each of which may be implemented within a software defined radio (SDR). The mitigation channels implement “mitigation techniques”, i.e., algorithms that detect a specific emission and generate a corresponding mitigating emission from transmit antennas 124.

Each mitigation channel applies one or more detection techniques to one or more sensing channels in order to detect a specific emission (e.g., received over reception antennas 126). SAMS 130 then transmits a corresponding mitigation signal using one or more transmission channels for broadcast over transmit antennas 124. Mitigation channels may also be applied to power channels such as those associated with power input devices 114.

### MCS 132 Characteristics

The MCS 132 exchanges control information with components of internal mitigation system 106 in order to configure it for the intended operations. The MCS 132 exchanges alarms and other emissions status information with SAMS 130.

The MCS 132 configures the internal mitigation system 106 to address considerations such as:
Adversary signal intercept system 104;
Authorized mitigation techniques;
Legal requirements (as determined by local jurisdiction);
Radiation safety level & calibration requirements;
Allow/deny lists for user devices 122;
Mission data set;
Power, BIT, self-test, and calibration orders; and
Timing synchronization
   Generally, MCS 132 utilizes the reception antennas 126 to monitor RF (or other) emissions from user devices 122. The MCS 132 can utilize various mitigation techniques to generate one or more mitigation signals via transmit antennas 124 to limit any RF potentially compromising transmissions from user devices 122 from exiting the confines of sensitive space boundary 102.

### Transmit Antennas 124 and Reception Antenna 126 Details and Operation

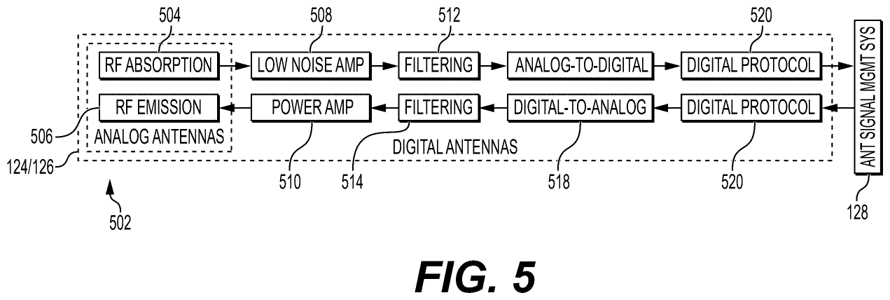

Preferably, the design of sensitive space boundary 102 avoids metallic cabling since that introduces emissions risks and can be hard to route in a secured space. In some embodiments, digital RF antennas with fiber optic connections and/or Bluetooth connections are preferred to avoid any signals from being intercepted. FIG. 5 depicts an example schematic of the components of a digital antenna 502 that can be used as a transmit antenna 124 or reception antenna 126. As shown, digital antenna may comprise analog reception antenna 504, analog transmission antenna 506, low noise amplifier 508, power amplifier 510, reception filters 512, transmission filters 514, A/D convertor 516, D/A converter 518, and digital protocol 520 for communicating with ASMS 128. If analog antennas are utilized, the components 508-520 may be provided by ASMS 128 directly to digitize the RF signals.

A/D convertor 516 and D/A convertor 518 may comprise modulation/demodulation and other signal manipulations and conversions. The reception antenna 504 or transmit antenna 506 may be omnidirectional (whip) or directional (horn) in order to isolate and amplify signals from specific user devices 122. The reception antenna 504 or transmit antenna 506 may be pointed towards an adversary system such as adversary signal intercept systems 104. The digital protocol 520 may utilize RF or an intermediate frequency.

### Power Monitoring and Distribution System 108 Details and Operation

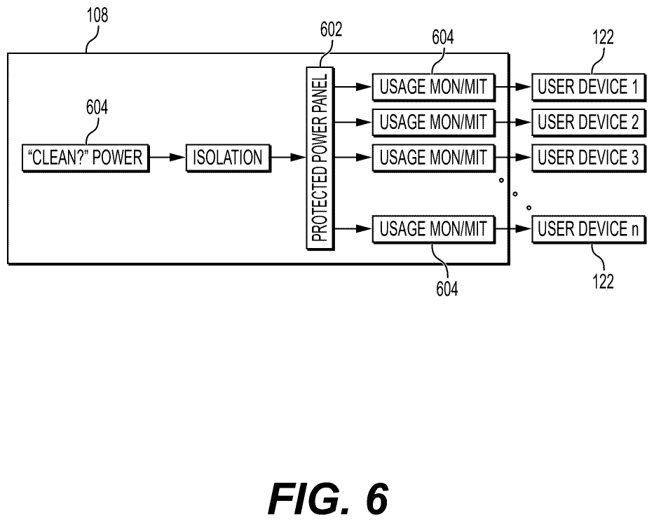

Generally, access to internal power within sensitive space boundary 102 is through one or more protected power panels 602 coupled to usage monitor and mitigation system 604. As depicted in FIG. 6, clean power is received from power source 604 by power monitoring and distribution system 108 which isolates and distributes power through protected power panels 602. Each port (e.g., plug, USB port, etc.) associated with protected power panel 602 comprises a usage monitor 604 which monitors all power to/from user devices 122. For example, the usage monitors 604 will monitor power usage, monitor out-of-band signals, and mitigate those out-of-band signals. Further, usage monitors 604 connect to the SAMS 130 using methods similar to those used for antennas 124 and 126. Similar architecture is used for both power and for ground(s) for power source 604. Several similar power or ground distribution networks 602 and 604 can be used to improve isolation.

### ASMS 128 Details and Operation

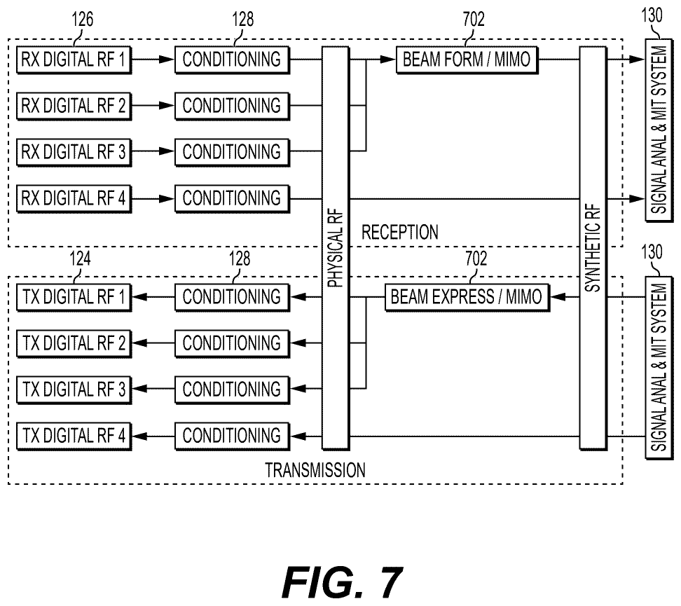

The ASMS 128 exchanges synthetic RF with the SAMS 130 and exchanges physical RF with the transmit antennas 124 and reception antennas 126. Beamforming and/or Multiple-In, Multiple Out (MIMO) techniques are used to create the virtual channels 702 as depicted in FIG. 7. The RF signals received by reception antennas 126 are conditioned (after being digitized) by ASMS 128 before being arranged into virtual channels 702 which are communicated to SAMS 130. Similarly, outgoing synthetic RF signals from SAMS are split, conditioned by ASMS 128, and then sent to different transmit antennas 124.

### SAMS 130 Details and Operation

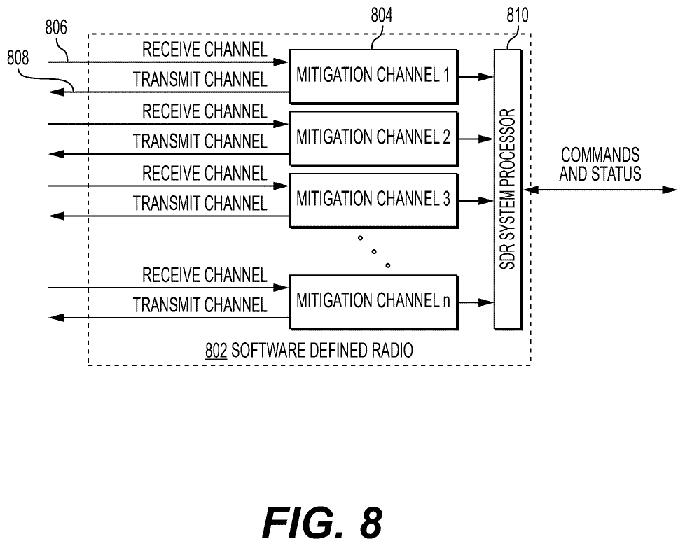

As previously discussed, the SAMS 130 comprises a plurality of “mitigation channels”, each of which may be implemented within a software defined radio (SDR) 802. FIG. 8 depicts a schematic diagram of SDR 802. Each mitigation channel 804 within SDR 802 is configured to provide a different type of mitigation technique to the receive channel 806 and/or transmit channel 808. As referred to herein, mitigation techniques are algorithms that detects a specific emission on receive channel 806 and generate a corresponding mitigating emission on transmit channel 808 that is transmitted by transmit antennas 124.

Each mitigation technique analyzes a received channel 806 (e.g., using SDR system processor 810) and uses that information to generate a mitigation signal for a transmit channel 808. The SDR system processor 810 hosts and coordinates mitigation channels 804 and mitigation technique assignments. The SDR system processor 810 further exchanges commands and status with the MCS 132.

Mitigation techniques are design to defeat an adversary's efforts using adversary signal intercept systems 104 to derive information from intercepted emissions. There are several general classes of mitigation techniques including:
Narrowband mitigation
Broadband mitigation (e.g., RF interference)
Protocol mitigation
New techniques mitigation
Specific techniques may be highly sensitive.

### Mitigation Control System 132 Details and Operation

As previously described, MCS 132 can use other system components, such as transmit antennas 124, to emit a mitigation signal to limit or reduce RF signals from user devices 122 from leaving sensitive space boundary 102. In general, MCS 132 analyzes all wired/wireless communications via data received from PMDS 108, external mitigation system 110, and internal mitigation system 106.

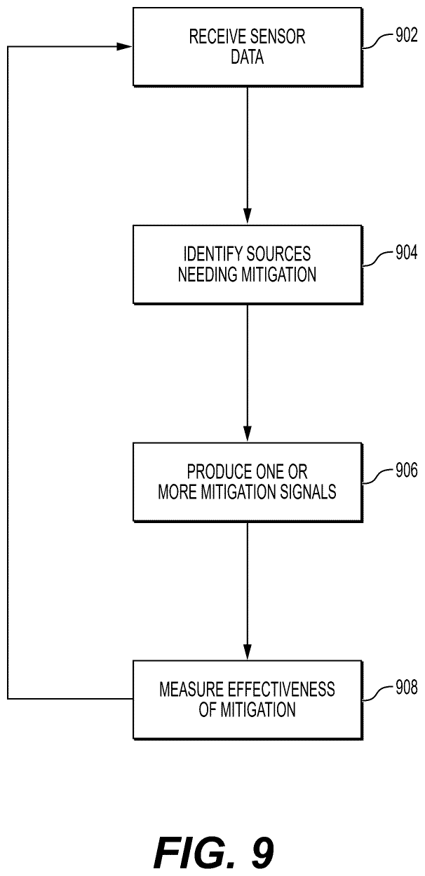

Generally, mitigation is performed continuously in a loop utilizing the steps depicted in FIG. 9. First, data is collected for signals that may need mitigation (e.g., RF signals from user device(s) 122) via internal mitigation system 106 in step 902. The received sensor information for each mitigation channel 804 is then processed by SDR system processor 810 in step 904 to identify any sources needing mitigation, such as components within user devices 122. For each mitigation channel 804, a mitigation signal is produced using one or more mitigation techniques in step 906. The mitigation signal provides specific output instructions for transmit antennas 124 to produce a corresponding mitigation signal. For example, a mitigation signal may cause two specific RF antennas 124 to direct a specific signal at a certain location using beamforming techniques.

After any mitigation techniques have been implemented, the results of the mitigation can be analyzed in step 908. For example, external mitigation system 110 may be employed to measure specific signals from a user device 122 to determine if the signal has been mitigated, dampened, or otherwise eliminated.

While specific embodiments of the invention have been described above, it will be appreciated that the invention may be practiced other than as described. The embodiment(s) described, and references in the specification to “one embodiment,” “an embodiment,” “an example embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to affect such feature, structure, or characteristic in connection with other embodiments whether or not explicitly described.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

1. An emissions mitigation system (EMS) for protecting friendly information processing components against hostile surveillance, the EMS comprising:
a mitigation system comprising:
an emissions sensor system for detecting emission signals from user devices within a sensitive space boundary;
an emissions signal processor for analyzing the emission signals and determining a mitigation signal for mitigating the emission signals;
an emanation signal system for producing the mitigation signal for mitigating the emission signals within the sensitive space boundary,
wherein the mitigation system protects the sensitive space boundary.

2. The EMS according to claim 1, further comprising:
a physical signal-mitigating enclosure within the sensitive space boundary.

3. The EMS according to claim 2, wherein the physical signal-mitigating enclosure is a sensitive compartmented information facility (SCIF).

4. The EMS according to claim 1, wherein the user devices are friendly information processing components that are not within a physical signal-mitigating enclosure.

5. The EMS according to claim 1, wherein the mitigation signal is automatically tuned based upon local emissions rules and regulations.

6. The EMS according to claim 5, wherein the tuning is a change in a signal strength of the mitigation signal.

7. The EMS according to claim 1, wherein the mitigation signal is automatically tuned based upon existing personnel safety regulations.

8. The EMS according to claim 1, wherein a size or a shape of the sensitive space boundary is configurable by the mitigation system.

9. The EMS according to claim 1, further comprising:
an external mitigation system located outside the sensitive space boundary,
wherein the external mitigation system comprises:
an external emissions sensor system for detecting internal emission signals from within the sensitive space boundary; and
an external emissions signal processor for analyzing the internal emission signals and determining an effectiveness rating of the mitigation signal.

10. The EMS according to claim 9, wherein the external emissions signal processor communicates the effectiveness rating to the emissions signal processor; and
wherein the emissions signal processor adjusts the mitigation signal based upon the effectiveness rating.

11. The EMS according to claim 9, wherein the external emissions sensor system further detects external emissions outside of the sensitive space boundary; and
wherein the external emissions signal processor automatically generates an alarm if compromising external emissions are detected.

12. The EMS according to claim 1, wherein the emissions sensor system comprises:
a plurality of radio frequency (RF) reception antennas,
wherein the plurality of RF reception antennas detect the emission signals; and
a plurality of RF transmission antennas,
wherein the RF transmission antennas emit the mitigation signal under control of the emissions signal processor.

13. The EMS according to claim 1, further comprising:
a power monitoring and distribution system for providing power to the user devices and for mitigating any secondary signals detected within a power grid of the power monitoring and distribution system.

14. The EMS according to claim 1, wherein the mitigation system further comprises:
an external emanations sensing system for detecting external emanations from outside the sensitive space boundary;
an external emanations signal processor for analyzing the external emanations,
wherein the external emanations signal processor generates an alarm if any hostile external emanations are detected.

15. An emissions mitigation method for protecting friendly information processing components against hostile surveillance, the method comprising:
detecting emission signals from user devices within a sensitive space boundary;
analyzing the emission signals by an emissions signal processor;
determining a mitigation signal for mitigating the emission signals; and
broadcasting the mitigation signal for mitigating the emission signals within the sensitive space boundary,
wherein the mitigation system protects the sensitive space boundary.

16. A non-transitory computer readable medium having stored thereon a program for protecting friendly information processing components against hostile surveillance, the program executing steps of:
detecting emission signals from user devices within a sensitive space boundary;
analyzing the emission signals by an emissions signal processor;
determining a mitigation signal for mitigating the emission signals; and
broadcasting the mitigation signal for mitigating the emission signals within the sensitive space boundary,
wherein the mitigation system protects the sensitive space boundary.
